(19) United States
(12) Patent Application Publication
(10) Pub. No.: US 2023/0229138 A1
(43) Pub. Date: Jul. 20, 2023

(54) MACHINING PATH CREATION DEVICE

(71) Applicant: FANUC CORPORATION, Yamanashi (JP)

(72) Inventors: Kei HAGIHARA, Yamanashi (JP); Yoshito MIYAZAKI, Yamanashi (JP)

(21) Appl. No.: 17/997,926

(22) PCT Filed: May 11, 2021
(86) PCT No.: PCT/JP2021/017878

§ 371 Date: Nov. 4, 2022

(30) Foreign Application Priority Data
May 14, 2020 (JP) 2020-084954

(51) Int. Cl. G05B 19/4103

(52) U.S. Cl. CPC G05B 19/4103; G05B 2219/34127

(57) ABSTRACT

A machining path creation device includes an analysis unit configured to create a machining path by analyzing a machining program, a shape determination unit configured to determine ON/OFF of a smoothing processing function at each part of the machining path, based on the shape of each part of the machining path created by the analysis unit, and a smoothing processing unit configured to perform smoothing processing on a part of the machining path in which the smoothing processing function is determined to be ON, and not to perform smoothing processing on a part of the machining path in which the smoothing processing function is determined to be OFF, based on a determination result obtained by the shape determination unit.

### RELATED APPLICATIONS

The present application is a National Phase of International Application No. PCT/JP2021/017878 filed May 11, 2021, which claims priority to Japanese Application No. 2020-084954, filed May 14, 2020.

### TECHNIQUE FIELD

The present invention relates to a machining path creation device, and more particularly to a machining path creation device having a function of smoothing a machining path instructed by a program.

### BACKGROUND ART

When a machine tool is used to perform machining, multiple command points each representing the relative position of a tool with respect to a workpiece are instructed in a machining program. A controller executes the machining program to cause the tool to move relative to the workpiece so that it passes through each command point, thereby machining the workpiece. A smoothing function is known, in which smoothing processing is applied to a tool movement path (machining path) that is formed by connecting respective command points. The smoothing function is used, for example, to make a machined surface smooth and superior in quality.

In general, in the smoothing processing, smoothing points are generated based on a smoothing curve, which can be obtained by setting a discrete value for each command point, with respect to a machining path given by command points. By setting a smoothing path passing through the generated smoothing points, the machining path can be optimized so that the machined surface becomes smooth. Exemplary techniques related to the smoothing processing include a technique using smooth tolerance control, a technique using a B-spline curve or a Bezier curve, and a technique using a simple mean value or a weighted mean value.

In the smoothing processing, even if the machining path is the same, the number of command points and the pattern of point sequence (an interval between command points) may be different. In such a case, a difference will be caused in the shape of the smoothing path obtained as a result of processing.

As a technique capable of coping with such a problem, there is a conventionally known technique for dividing an interval between command points at regular intervals and performing smoothing processing by regarding these division points as command points (for example, Patent Literature 1).

### CITATION LIST

### Patent Literature

[Patent Literature 1] Japanese Patent Laid-Open No. 2018-073097

### SUMMARY OF INVENTION

### Technical Problem

However, a machining program created by an operator may include a portion at which machining with a machining path having straight lines and vertices, without smoothing a machining surface, is desired. Performing smoothing processing according to the machining program including such a portion will smooth the portion at which machining with the machining path having straight lines and vertices is desired. Therefore, there is a problem that a realized machining shape will be far from an originally expected one and an object to be machined becomes defective.

To solve this problem, it may be possible to set many division points, for example, for a straight line or a part where a vertex is to be represented, so as to divide the straight line finely or so as to divide line segments forming a vertex finely. However, no matter how many division points are provided, it will take the form of interpolation configured by minute curves. Therefore, it is unfeasible to maintain the accuracy as desired. In addition, the increase in smoothing processing load due to the increase in the number of division points will arise as another problem.

As another countermeasure, it will be possible to add a description about a command with respect to ON/OFF of the smoothing processing in the machining program. That is, it is feasible to prevent the smoothing processing from being performed on a part at which maintaining the shape such as a straight line or a vertex is required. However, in this case, it is necessary to additionally describe the command in the machining program at all the parts where switching is performed with respect to ON/OFF of the smoothing processing. As a result, a problem arises in that an operator's burden increases when creating the machining program.

Therefore, a technique for automatically determining the ON/OFF of the smoothing processing based on a predetermined standard is desired.

### Solution to Problem

An aspect of the present invention intends to solve the above-described problem by using a parameter depending on the shape when determining ON/OFF of the smoothing processing.

More specifically, a parameter related to the curvature is used when determining ON/OFF of the smoothing processing. In general, a large change in the curvature related parameter occurs at a part where a machining path having the shape such as a straight line or a vertex abruptly changes. In many cases, the change in the curvature related parameter is smaller before and after this part. Therefore, this tendency is reflected to the determination.

Further, one aspect of the present invention is a machining path creation device that creates a machining path that is a movement path of a tool with respect to a workpiece based on a machining program. The machining path creation device includes an analysis unit configured to create a machining path by analyzing the machining program, a shape determination unit configured to determine ON/OFF of a smoothing processing function at each part of the machining path, based on the shape of each part of the machining path created by the analysis unit, and a smoothing processing unit configured to perform smoothing processing on a part of the machining path in which the smoothing processing function is determined to be ON, and not to perform smoothing processing on a part of the machining path in which the smoothing processing function is determined to be OFF, based on a determination result obtained by the shape determination unit.

### Advantageous Effects of Invention

According to one aspect of the present invention, by using a parameter depending on the shape to identify a part where the machining path changes abruptly, smoothing can be applied to a workpiece having a complicated shape. Since the curvature related parameter does not depend on the fineness of the command point, it is possible to accurately determine the part where the machining path changes abruptly.

### BRIEF DESCRIPTION OF DRAWINGS

FIG. 1 is a schematic hardware configuration diagram illustrating a machining path creation device according to a first embodiment.

FIG. 2 is a schematic functional block diagram illustrating the machining path creation device according to the first embodiment.

FIG. 3 is a diagram illustrating an exemplary determination operation by a shape determination unit.

FIG. 4 is a diagram illustrating an exemplary operation result of a smoothing processing unit.

FIG. 5 is a schematic hardware configuration diagram illustrating a machining path creation device according to a second embodiment.

FIG. 6 is a schematic functional block diagram illustrating the machining path creation device according to the second embodiment.

### DESCRIPTION OF EMBODIMENTS

Hereinafter, embodiments of the present invention will be described with reference to attached drawings.

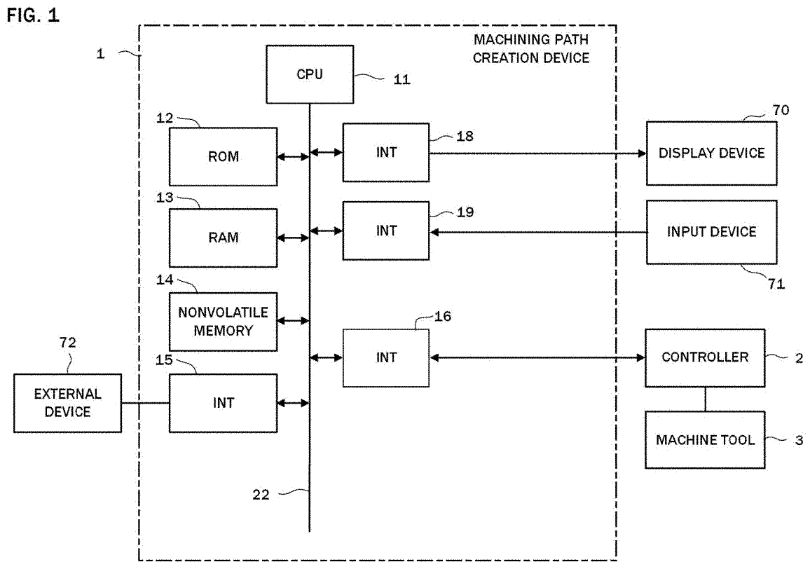

FIG. 1 is a schematic hardware configuration diagram illustrating a machining path creation device according to the first embodiment. The machining path creation device 1 can be implemented in a controller configured to control an industrial machine such as a machine tool that performs machining. Further, the machining path creation device 1 can be implemented in, for example, a personal computer attached to a controller controlling a machine tool, a personal computer connected to this controller via a wired/wireless network, a fog computer, a cloud server, or the like. In the present embodiment, an example in which the machining path creation device 1 is implemented in the personal computer attached to the controller controlling the machine tool will be described.

The CPU 11 included in the machining path creation device 1 is a processor that controls, as a whole, the machining path creation device 1. The CPU 11 reads out a system program stored in a ROM 12 via a bus 22, and controls the machining path creation device 1, as a whole, according to the system program. Temporary calculation data, display data, and various data input from the outside are temporarily stored in a RAM 13.

A nonvolatile memory 14 is configured by, for example, a memory or a solid state drive (SSD) backed up by a battery (not illustrated). The nonvolatile memory 14 holds a storage state even when the machining path creation device 1 is powered off. The nonvolatile memory 14 stores data and each machining program, which have been read via an interface 15 from an external device 72. Further, the nonvolatile memory 14 stores data and each machining program acquired via an interface 16 from a controller 2. Moreover, the nonvolatile memory 14 stores data and each machining program, when they are input via an input device 71. The data and each machining program stored in the nonvolatile memory 14 may be loaded into the RAM 13 at the time of execution/use. Further, various system program such as conventionally known processing programs and analysis programs are written in advance in the ROM 12.

The interface 15 is an interface for connecting the CPU 11 of the machining path creation device 1 and the external device 72 such as a USB device. For example, the machining program and various parameters to be used for controlling the machine tool can be read from the external device 72. Further, the machining program and various parameters edited in the machining path creation device 1 can be stored, via the external device 72, in external storage means.

For example, each data read in the nonvolatile memory 14, data obtained as a result of execution of the machining program or the system program, and the like are output via an interface 18 and displayed on a display device 70. Further, the input device 71 consisting of a keyboard, a pointing device or the like sends each command and data based on a worker's operation, via an interface 19, to the CPU 11.

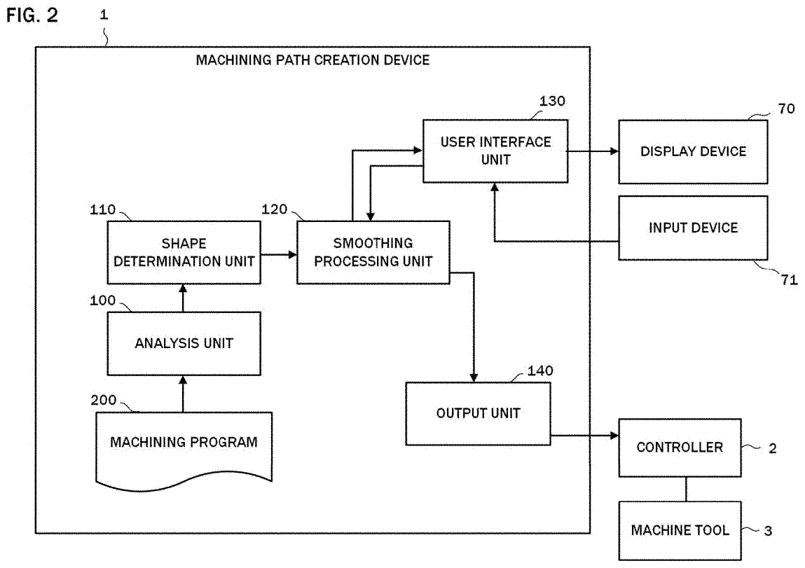

FIG. 2 is a schematic block diagram illustrating functions of the machining path creation device 1 according to the first embodiment. Each function of the machining path creation device 1 of the present embodiment can be realized when the CPU 11 executes the system program and controls the operation of each part of the machining path creation device 1.

The machining path creation device 1 includes an analysis unit 100, a shape determination unit 110, a smoothing processing unit 120, a user interface unit 130, and an output unit 140. Further, a machining program 200 acquired from the controller 2, the input device 71, the external device 72 or the like is stored in advance in the RAM 13 or the nonvolatile memory 14 of the machining path creation device 1.

The analysis unit 100 can be realized when the CPU 11 executes the system program read out from the ROM 12 and arithmetic processing is performed mainly by the CPU 11 using the RAM 13 and the nonvolatile memory 14. The analysis unit 100 analyzes a block of operation commands for a machine tool 3 in the machining program 200. Then, the analysis unit 100 creates a machining path of a tool provided in the machine tool 3 based on a result of this analysis. The analysis unit 100 outputs data related to the created machining path to the shape determination unit 110.

The shape determination unit 110 can be realized when the CPU 11 executes the system program read out from the ROM 12 and arithmetic processing is performed mainly by the CPU 11 using the RAM 13 and the nonvolatile memory 14. The shape determination unit 110 determines the shape of each part of the machining path based on the data related to the machining path input from the analysis unit 100. For example, the shape determination unit 110 calculates the curvature at the position of each command point of the machining path, and determines the shape of each part of the machining path based on this curvature. The curvature at the position of each command point of the machining path can be obtained, for example, by performing provisional smoothing processing on the machining path, calculating a curvature κ in the vicinity of each command point of the obtained smoothing curve using the following Expression 1, and regarding the calculated value as the curvature at this command point. In Expression 1, f′(a) and f″(a) are a derivative and a second-order derivative at the position of x=a when y=f(x) is a mathematical function representing the smoothing curve obtained by the provisional smoothing processing applied to the machining path. The method for calculating the curvature is not limited to Expression 1, and other general techniques can be appropriately adopted.

$$k = \frac{{f}^{″} ( a )}{{( 1 + {{f}^{′} ( a )}^{2} )}^{\frac{3}{2}}} \qquad [ Expression 1 ]$$

For each command point at which the curvature is equal to or greater than (or exceeds) a predetermined threshold Th_{κ}, the shape determination unit 110 determines setting the smoothing processing to OFF (regards this point as an object to be excluded from the smoothing processing). For each command point at which the curvature is less than (or not greater than) the predetermined threshold Th_{κ}, the shape determination unit 110 may determine setting the smoothing processing to ON (may regard this point as an object to be subjected to the smoothing processing). The shape determination unit 110 outputs the determination result with respect to ON/OFF of the smoothing processing at each command point to the smoothing processing unit 120.

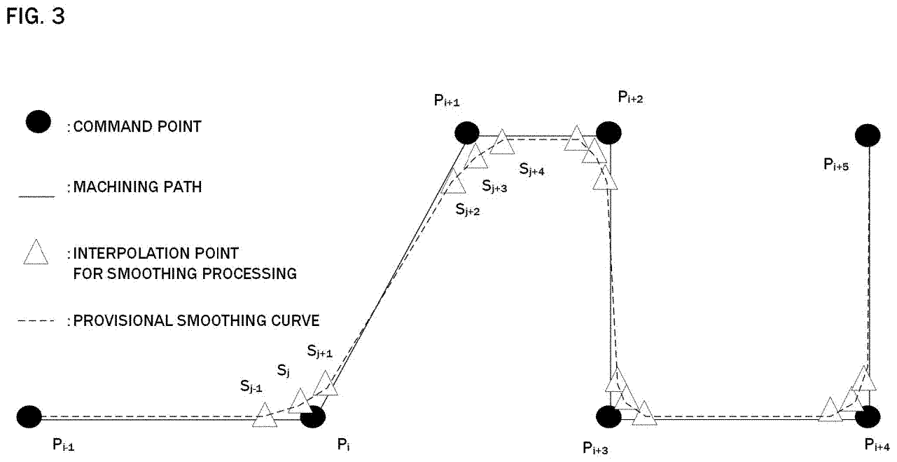

FIG. 3 illustrates an example of the machining path instructed by the machining program 200. According to the example illustrated in FIG. 3, it is assumed that command points Pᵢ₋₁ to Pᵢ₊₅ are instructed by the machining program 200 and the smoothing processing is performed by a smooth tolerant control. At this time, the shape determination unit 110 first performs provisional smoothing on the machining path instructed by the command points Pᵢ₋₁ to Pᵢ₊₅ by the smooth tolerant control, and calculates a provisional smoothing curve. Then, the shape determination unit 110 calculates the curvature of the provisional smoothing curve in the vicinity of each of the command points Pᵢ₋₁ to Pᵢ₊₅ (for example, the curvature at a point closest to the command point among interpolation points calculated for the smoothing processing) as the curvature at this command point. For example, the threshold Th_{κ} is set to be larger than the curvatures at the command points Pᵢ and Pᵢ₊₁ and smaller than the curvatures at the command points Pᵢ₊₂ to Pᵢ₊₄, in advance. In this case, the shape determination unit 110 determines setting the smoothing processing to OFF for the machining path that bends at a substantially right angle, and for the machining path that bends at an acute angle.

The smoothing processing unit 120 can be realized when the CPU 11 executes the system program read out from the ROM 12 and arithmetic processing is performed mainly by the CPU 11 using the RAM 13 and the nonvolatile memory 14. The smoothing processing unit 120 performs smoothing processing on the machining path based on the determination result with respect to ON/OFF of the smoothing processing at each command point input from the shape determination unit 110. At the command point where the shape determination unit 110 has determined setting the smoothing processing to ON, the smoothing processing unit 120 performs smoothing processing. Further, at the command point where the shape determination unit 110 has determined setting the smoothing processing to OFF, the smoothing processing unit 120 does not perform smoothing processing and does not change the machining path. The machining path created by the smoothing processing unit 120 is output to the user interface unit 130.

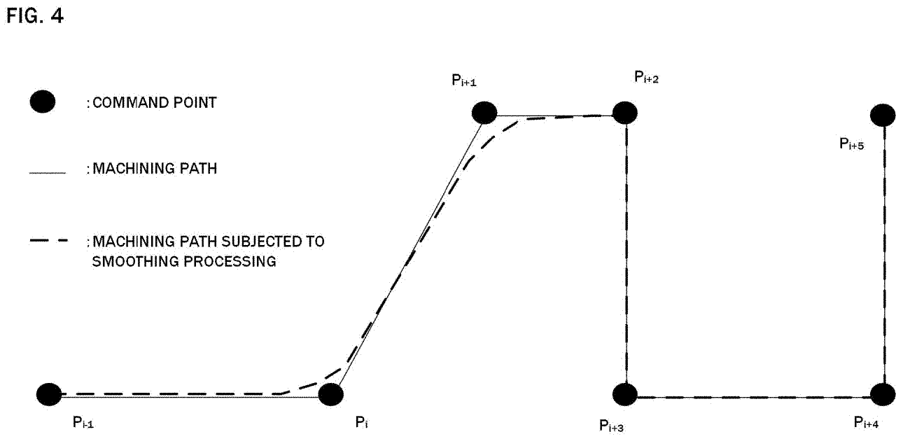

FIG. 4 is a diagram illustrating a result of the smoothing processing by the smoothing processing unit 120 in the case where, in the example illustrated in FIG. 3, the threshold Th_{κ} is set to be greater than the curvatures at the command points Pᵢ and Pᵢ₊₁ and smaller than the curvatures at the command points Pᵢ₊₂ to Pᵢ₊₄. As exemplarily illustrated in FIG. 4, based on the determination by the shape determination unit 110, the smoothing processing is executed at the command points Pᵢ and Pᵢ₊₁ and the smoothing processing is not executed at the command points Pᵢ₊₂ to Pᵢ₊₄. As a result, an original machining path is output.

The user interface unit 130 can be realized when the CPU 11 executes the system program read out from the ROM 12, arithmetic processing is performed mainly by the CPU 11 using the RAM 13 and the nonvolatile memory 14, and output processing using the interface 18 is performed. The user interface unit 130 displays, on the display device 70, the machining path subjected to the smoothing processing by the smoothing processing unit 120 according to the determination result of the shape determination unit 110. For example, the user interface unit 130 may display each command point determined to be ON with respect to the smoothing processing and each command point determined to be OFF with respect to the smoothing processing so that they are identified on the machining path subjected to the smoothing processing. Further, the user interface unit 130 may accept, from an operator, an input for modifying ON/OFF of the smoothing processing at each command point. Then, the user interface unit 130 may instruct the smoothing processing unit 120 to perform the smoothing processing again in consideration of the modification by the operator with respect to ON/OFF of the smoothing processing for each command point. The user interface unit 130 may accept, from an operator, a command for outputting the machining path subjected to the smoothing processing by the smoothing processing unit 120 to the output unit 140.

Further, the output unit 140 can be realized when the CPU 11 executes the system program read out from the ROM 12, arithmetic processing is performed mainly by the CPU 11 using the RAM 13 and the nonvolatile memory 14, and output processing using the interface 18 is performed. The output unit 140 outputs the machining path subjected to the smoothing processing by the smoothing processing unit 120 to the controller 2. The output unit 140 may output, to the controller 2, a block including a command for causing a tool to move along the machining path subjected to the smoothing processing, which is replaced with a predetermined block of the machining program 200.

The machining path creation device 1 according to the present embodiment having the above-described configuration determines whether to set ON or OFF with respect to the smoothing processing at each command point based on the shape at this command point, for the machining path instructed by the machining program 200. Therefore, even when an operator does not embed an ON/OFF command with respect to the smoothing processing in the machining program in advance, the ON/OFF of the smoothing processing at each command point can be determined automatically. The operator can confirm the machining path created as an automatically determined result, and can modify the ON/OFF of the smoothing processing at some command points if necessary. Further, by outputting the modified machining path to the controller 2, machining can be performed. Therefore, the operator's labor in creating the machining program can be reduced.

As a modified embodiment of the machining path creation device 1 according to the present embodiment, the shape determination unit 110 may be configured to determine the shape of each part of the machining path, for example, based on a change in curvature at the position of each command point. The change in curvature at the position of each command point of the machining path may be determined by using, for example, the amount of change in curvature α calculated by the following Expression 2. In Expression 2, Rᵢ (i is a positive integer) represents the radius of curvature at the position of each command point Pᵢ (i is a positive integer and P₀ represents the first command point) of the machining path. The radius of curvature at the position of a command point can be obtained by performing provisional smoothing processing on the machining path, calculating the radius of curvature R in the vicinity of each command point of the obtained smoothing curve using the following Expression 3, and regarding the calculated value as the radius of curvature at this command point. Further, in Expression 2, Rsᵢ represents the radius of curvature at an interpolation point (Sⱼ₋₁ in the example illustrated in FIG. 3) immediately before an interpolation point (Sⱼ in the example illustrated in FIG. 3) for smoothing processing positioned in the vicinity of the command point Pᵢ. Further, in Expression 3, f′(a) and f″(a) are a derivative and a second-order derivative at the position of x=a when y=f(x) is a mathematical function representing the smoothing curve obtained by the provisional smoothing processing applied to the machining path.

$$α = \vert {R}_{i} - R {s}_{i} \vert \qquad [ Expression 2 ]$$

$$R = \frac{{( 1 + {{f}^{′} ( a )}^{2} )}^{\frac{3}{2}}}{\vert {f}^{″} ( a ) \vert} \qquad [ Expression 3 ]$$

In the case of using the amount of change in curvature, for a command point where the amount of change in curvature is equal to or greater than (or exceeds) a predetermined threshold Th_{α}, the shape determination unit 110 determines setting the smoothing processing to OFF (regards this point as an object to be excluded from the smoothing processing). Further, for a command point where the curvature is less than (or not greater than) the predetermined threshold Th_{α}, the shape determination unit 110 may determine setting the smoothing processing to ON (may regard this point as an object to be subjected to the smoothing processing).

Further, the change in curvature at the position of each command point of the machining path may be determined by using, for example, a rate of change in curvature β calculated by the following Expression 4.

$$β = \frac{{R}_{i}}{{Rs}_{i}} \qquad [ Expression 4 ]$$

In the case of using the rate of change in curvature, for a command point where the rate of change in curvature is separated from 1 by an amount equal to or greater (or exceeding) a predetermined threshold Th_{β}, the shape determination unit 110 determines setting the smoothing processing to OFF (regards this point as an object to be excluded from the smoothing processing). Further, for a command point where the rate of change in curvature is in a range of less than (or not greater than) the predetermined threshold Th_{β} from 1, the shape determination unit 110 may determine setting the smoothing processing to ON (may regard this point as an object to be subjected to the smoothing processing).

The method for calculating the change in curvature is not limited to the above-mentioned technique for obtaining the amount of change in curvature or the rate of change in curvature, and other general techniques can be appropriately adopted.

The machining path creation device 1 according to the present modified embodiment determines whether to set the smoothing processing at each command point to ON or OFF based on the change in curvature at the command point, for the machining path instructed by the machining program 200. The value indicating the change in curvature takes a large value at a part where the machining path changes from a gentle bend to a sharp bend, and a part where the machining path changes from a sharp bend to a gentle bend. Therefore, in general, there is the tendency that the smoothing processing is set to OFF at a specific portion where a sharp change is intended by the operator, namely at a portion intended to be machined at an acute angle, and set to ON at other portions. Therefore, it is possible to control the smoothing processing so as to more reflect the operator's intention.

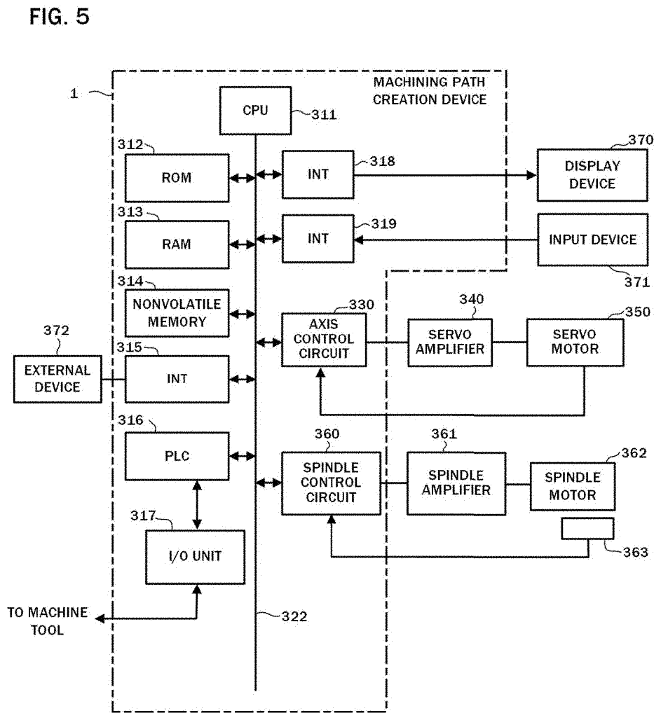

FIG. 5 is a schematic hardware configuration diagram illustrating a machining path creation device according to a second embodiment. In this embodiment, an example of the machining path creation device 1 implemented in a controller for controlling a machine tool is illustrated.

The machining path creation device 1 includes a CPU 311, which is a processor that controls the machining path creation device 1 as a whole. The CPU 311 reads out, via a bus 322, the system program stored in a ROM 312, and controls the entire machining path creation device 1 according to the system program. Temporary calculation data, display data, and various data input from the outside are temporarily stored in a RAM 313.

A nonvolatile memory 314 is configured by, for example, a memory backed up by a battery or a solid state drive (SSD) (not illustrated). The nonvolatile memory 314 holds a storage state even when the machining path creation device 1 is powered off. The nonvolatile memory 314 stores data and each machining program, which have been read via an interface 315 from an external device 372. Further, the nonvolatile memory 314 stores data and each machining program input via an input device 371, each data acquired from the machine tool, and the like. The data and each machining program stored in the nonvolatile memory 314 may be loaded into the RAM 313 at the time of execution/use. Further, various system programs such as conventionally known analysis programs are written in advance in the ROM 312.

The interface 315 is an interface for connecting the CPU 311 and the external device 372 such as a USB device. For example, the machining program and various parameters to be used for controlling the machine tool can be read from the external device 372. Further, the machining program and various parameters edited in the machining path creation device 1 can be stored, via the external device 372, in external storage means. A programmable logic controller (PLC) 316 outputs signals, via an I/O unit 317, to the machine tool and peripheral devices (for example, a tool exchanger, an actuator such as a robot, sensors attached to the machine tool) of the machine tool and controls them, with a sequence program incorporated in the machining path creation device 1. Further, the PLC 316 receives signals from various switches of an operation panel installed in the main body of an industrial machine and peripheral devices, performs necessary signal processing, and then sends the signals to the CPU 311.

Each data read in the memory, data obtained as a result of execution of the machining program or the system program, and the like are output via an interface 318 and displayed on a display device 370. Further, the input device 371 configured by a keyboard or a pointing device sends each command and data based on a worker's operation, via an interface 319, to the CPU 11.

An axis control circuit 330 for controlling the axis provided in the machine tool receives a command indicating the movement amount of the axis from the CPU 311, and outputs the command of the axis to a servo amplifier 340. In response to this command, the servo amplifier 340 drives a servo motor 350 that moves a driving unit provided in the machine tool along the axis. The servo motor 350 of the axis has a built-in position/speed detector, and feeds back a position/speed feedback signal from the position/speed detector to the axis control circuit 330. As a result, the position/speed feedback control can be performed. Although the hardware configuration diagram of FIG. 5 illustrates each of the axis control circuit 330, the servo amplifier 340, and the servo motor 350 as a single constituent component, the number of these components will actually be prepared so as to correspond to the number of axes provided in a machine tool to be actually controlled. For example, when controlling a general machine tool, three sets of the axis control circuit 330, the servo amplifier 340, and the servo motor 350 are prepared to cause the spindle to which the tool is attached and the workpiece to move relatively in the directions of three straight lines (X-axis, Y-axis, and Z-axis).

A spindle control circuit 360 receives a spindle rotation command, and outputs a spindle speed signal to a spindle amplifier 361. In response to this spindle speed signal, the spindle amplifier 361 causes a spindle motor 362 of the machine tool to rotate at a commanded rotation speed, thereby driving the tool. A position coder 363 is coupled to the spindle motor 362, and the position coder 363 outputs a feedback pulse in synchronization with the rotation of the spindle. This feedback pulse is read by the CPU 311.

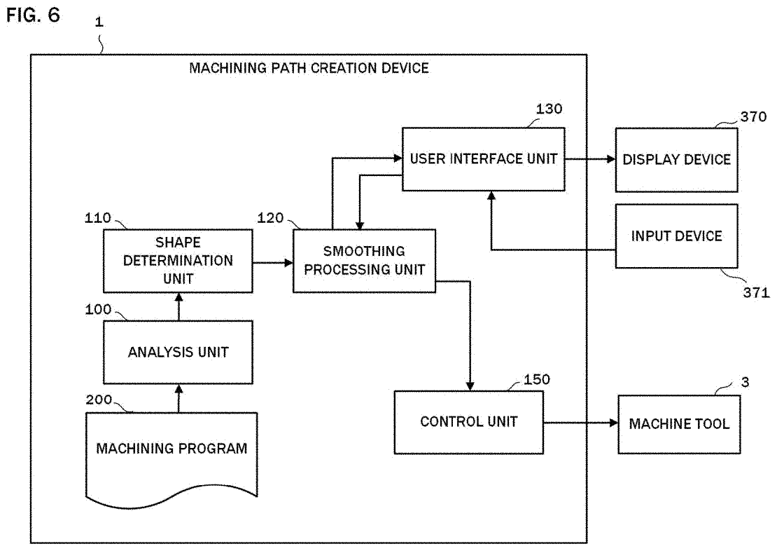

FIG. 6 is a schematic block diagram illustrating functions of the machining path creation device 1 according to the second embodiment. Each function of the machining path creation device 1 according to the present embodiment can be realized when the CPU 311 included in the machining path creation device 1 illustrated in FIG. 5 executes the system program to control the operation of each part of the machining path creation device 1.

The machining path creation device 1 includes the analysis unit 100, the shape determination unit 110, the smoothing processing unit 120, the user interface unit 130, and a control unit 150. Further, the machining program 200 acquired from the controller 2, the input device 71, the external device 72 is stored in advance in the RAM 13 and the nonvolatile memory 14 of the machining path creation device 1.

The shape determination unit 110, the smoothing processing unit 120, and the user interface unit 130 according to the present embodiment are functionally similar to those described in the first embodiment.

The analysis unit 100 can be realized when the CPU 311 executes the system program read out from the ROM 312 and arithmetic processing is performed mainly by the CPU 311 using the RAM 313 and the nonvolatile memory 314. The analysis unit 100 analyzes the block of operation commands for the machine tool 3 from the machining program 200. Then, based on the analysis result, command data is created for instructing the operations of the servo motor 350 and the spindle motor 362 included in the machine tool 3. Of the command data, the data related to the machining path of the tool is output to the shape determination unit 110. Further, the command data for instructing the operations of the spindle motor 362 and peripheral devices is output to the control unit 150.

The control unit 150 can be realized when the CPU 311 executes the system program read out from the ROM 312, arithmetic processing is performed mainly by the CPU 311 using the RAM 313 and the nonvolatile memory 314, and control processing for each part of the machine tool 3 using the axis control circuit 330, the spindle control circuit 360, and the PLC 316 is performed. The control unit 150 controls each axis of the machine tool 3, based on the machining path obtained by the smoothing processing unit 120 performing the smoothing processing, so as to control the relative movement between the workpiece and the tool. Further, for example, the control unit 150 generates data related to the rotation of the spindle based on the command data that causes the spindle of the machine tool 3 to rotate, and outputs the generated data to the spindle motor 362. Further, for example, the control unit 150 generates a predetermined signal for operating a peripheral device of the machine tool 3 based on the command data that causes the peripheral device to operate, and outputs the generated signal to the PLC 316.

The machining path creation device 1 according to the present embodiment having the above-described configuration determines whether to set the smoothing processing at each command point to ON or OFF based on the shape at the command point, for the machining path instructed by the machining program 200. Therefore, even when an operator does not embed an ON/OFF command with respect to the smoothing processing in the machining program in advance, the ON/OFF of the smoothing processing at each command point can be determined automatically, and a tool movement control based on the determination result can be performed.

Although some embodiments of the present invention have been described above, the present invention is not limited to the example embodiments and can be implemented in various embodiments by making appropriate changes.

1. A machining path creation device that creates a machining path that is a movement path of a tool with respect to a workpiece based on a machining program, the machining path creation device comprising:
an analysis unit configured to create a machining path by analyzing the machining program;
a shape determination unit configured to determine ON/OFF of a smoothing processing function at each part of the machining path, based on a shape of each part of the machining path created by the analysis unit; and
a smoothing processing unit configured to perform smoothing processing on a part of the machining path in which the smoothing processing function is determined to be ON, and not to perform smoothing processing on a part of the machining path in which the smoothing processing function is determined to be OFF, based on a determination result obtained by the shape determination unit.

2. The machining path creation device according to claim 1, wherein the shape determination unit determines a shape of each part of the machining path based on a curvature at a command point of the machining path.

3. The machining path creation device according to claim 1, wherein the shape determination unit determines a shape of each part of the machining path based on a change in curvature at a command point of the machining path.
